(19) United States
(12) Patent Application Publication
(10) Pub. No.: US 2026/0228987 A1
(43) Pub. Date: Aug. 6, 2026

(54) METHOD, APPARATUS, DEVICE AND STORAGE MEDIUM FOR INTERACTING IN VIRTUAL ENVIRONMENT

(71) Applicant: Beijing Zitiao Network Technology Co., Ltd., Beijing (CN)

(72) Inventors: Chao Zhou, Beijing (CN); Chunxu Wang, Beijing (CN)

(21) Appl. No.: 19/159,163

(22) PCT Filed: Feb. 20, 2024
(86) PCT No.: PCT/CN2024/077813

§ 371 Date: Aug. 22, 2025

(30) Foreign Application Priority Data
Feb. 23, 2023 (CN) 202310193539.2

(51) Int. Cl. G06T 19/00; G06F 3/04815; G06T 19/20

(52) U.S. Cl. CPC G06T 19/006; G06F 3/04815; G06T 19/20; G06T 2219/2024

(57) ABSTRACT

Embodiments of the disclosure provide a method for interacting in a virtual environment. According to the method, a control module of a user device displays a virtual object, at least one interactable element associated with the virtual object, and a virtual manipulation member in a virtual environment via the user device. The method further includes detecting a predetermined operation of a user, via the virtual manipulation member, for an interactable element among the at least one interactable element, and in response to detecting a first predetermined operation for the interactable element, rendering the corresponding appearance of the virtual object with the image rendering data associated with the interactable element.

### CROSS REFERENCE

This application is the U.S. National Stage of International Application No. PCT/CN2024/077813, filed on Feb. 20, 2024, which claims the priority of China Patent Application No. 202310193539.2, filed on Feb. 23, 2023, and entitled “METHOD, APPARATUS, DEVICE AND STORAGE MEDIUM FOR INTERACTING IN VIRTUAL ENVIRONMENT”, the entire content of which is incorporated herein by reference.

### FIELD

Example embodiments of the present disclosure generally relate to the field of human-computer interaction, and more specifically, relate to a method, an apparatus, a device and a computer-readable storage medium for virtual environments.

### BACKGROUND

In the application of virtual environment based on 3D technology, a vivid virtual environment may be presented to users via user device. In the virtual environment, at least one virtual object and optionally one or more real world physical objects may be displayed to the user. In some implementations, a virtual manipulation member may be displayed to a user in a virtual environment so that the user can interact with other virtual objects in the virtual environment through the virtual manipulation member in the virtual environment. In this way, a more intuitive human-computer interaction experience can be realized. In some implementations, the device/service provider usually renders the virtual object of the virtual manipulation member as a default 3D model. However, the visual effect of this default 3D model is single and cannot meet the personalized needs of users.

### SUMMARY

In a first aspect of the present disclosure, a method for interacting in a virtual environment is provided. The method includes displaying, via a user device, at least one interactable element associated with a virtual object in a virtual environment, the at least one interactable element each being associated with image rendering data for rendering a corresponding appearance of the virtual object; detecting a predetermined operation of a user for an interactable element among the at least one interactable element; and in response to detecting a first predetermined operation for the interactable element, rendering the corresponding appearance of the virtual object with the image rendering data associated with the interactable element.

In a second aspect of the present disclosure, an apparatus for interacting in a virtual environment is provided. The apparatus includes a display module configured to display, via a user device, at least one interactable element associated with a virtual object in a virtual environment, where the at least one interactable element each is associated with image rendering data for rendering a corresponding appearance of the virtual object; a detecting module configured to detect a predetermined operation of a user for an interactable element among the at least one interactable element; and a rendering module configured to in response to detecting a first predetermined operation for the interactable element, render the corresponding appearance of the virtual object with the image rendering data associated with the interactable element.

In a third aspect of the present disclosure, an electronic device is provided. The electronic device includes at least one processing unit; and at least one memory coupled to the at least one processing unit and storing instructions executable by the at least one processing unit. The instructions, when executed by at least one processing unit, causing an electronic device to perform the method according to the first aspect of the present disclosure.

In a fourth aspect of the present disclosure, a non-transitory computer-readable storage medium is provided. The computer-readable storage medium stores a computer program, and the computer program can be executed by a processor to perform the method according to the first aspect of the present disclosure.

It should be understood that what is described in this Summary is not intended to define key features or important features of the embodiments of the present disclosure, nor is it intended to limit the scope of the present disclosure. Other features of the present disclosure will be readily understood from the following description.

### BRIEF DESCRIPTION OF DRAWINGS

Hereinafter, the above and other features, advantages and aspects of various implementations of the present disclosure will become more apparent with reference to the following detailed description in conjunction with the drawings. In the drawings, the same or similar reference numerals indicate the same or similar elements, in which:

FIG. 1 shows a schematic diagram of an example environment in which embodiments of the present disclosure can be implemented;

FIG. 2A shows a flowchart of an example interaction process in a virtual environment according to some embodiments of the present disclosure;

FIG. 2B shows a flowchart of an example process of detecting a first predetermined operation according to some embodiments of the present disclosure;

FIG. 3 shows a block diagram of an example interactive system in a virtual environment according to some embodiments of the present disclosure;

FIG. 4 illustrates an example virtual environment according to some embodiments of the present disclosure;

FIG. 5 shows a block diagram of an apparatus for augmented reality according to some embodiments of the present disclosure; and

FIG. 6 shows a block diagram of a device capable of implementing various embodiments of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be realized in various forms and should not be construed as limited to the embodiments set forth here, on the contrary, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term “including” and similar terms should be understood as open inclusion, that is, “including but not limited to”. The term “based on” should be understood as “based at least partially on”. The term “one embodiment” or “the embodiment” should be understood as “at least one embodiment”. The term “some embodiments” should be understood as “at least some embodiments”. The following may further include other explicit and implicit definitions.

The term “in response to” indicates that a corresponding event occurs, or a condition is satisfied. It will be understood that the execution timing of the subsequent actions performed in response to the event or condition is not necessarily strongly related to the time when the event occurs, or the condition is satisfied. In some cases, follow-up actions can be performed immediately when an event occurs or a condition is established; in other cases, the follow-up actions may be performed after an event occurs or a condition is established.

It is understandable that the data involved in this technical solution (including but not limited to the data itself, the acquisition or use of the data) shall comply with the requirements of relevant laws, regulations and relevant provisions.

It may be understood that before using the technical solution disclosed in various embodiments of the present disclosure, users should be informed of the types, scope of use, use scenarios, and the like of personal information involved in the present disclosure in an appropriate way according to relevant laws and regulations, and be authorized by users.

For example, in response to receiving the user's active request, prompt information is sent to the user to clearly remind the user that the operation requested by the user will require obtaining and using the user's personal information, so that the user can independently choose whether to provide personal information to software or hardware e.g., electronic device, application programs, servers or storage medium that perform the operation of the technical solution of the present disclosure according to the prompt information.

As an optional but non-limiting implementation, in response to receiving an active request from the user, the prompt information is sent to the user in the form of, for example, a pop-up window, in which the prompt information may be presented in text form. In addition, the pop-up window can also carry a selection control for the user to choose “agree” or “disagree” to provide personal information to the electronic device.

It is understandable that the above notification and the process of obtaining user authorization are merely illustrative and do not constitute a limitation of the implementation of the present disclosure, other modes that meet the relevant laws and regulations may also be applied to the implementation of the present disclosure.

As briefly discussed above, in the application of virtual environment based on 3D technology, a vivid virtual environment may be presented to users via user device. In some implementations, a virtual manipulation member may be displayed to a user in a virtual environment, so that the user can interact with other virtual objects in the virtual environment through the virtual manipulation member in the virtual environment, thereby realizing an immersive interactive experience.

In some implementations, the device/service provider usually presents the visual effects of virtual objects as a default 3D model. However, this default 3D model cannot meet the personalized needs of users. In other words, in the traditional solution, the visual presentation of virtual objects is limited to the default configuration of the system and lacks personalized customization mechanism.

In view of this, an interactive solution in a virtual environment is needed, so that users can customize personalized 3D models for avatar according to their personal preferences.

An embodiment of the present disclosure proposes an interaction solution in a virtual environment. According to the method described herein, a control module of a user device displays at least one interactable element in association with a virtual object in a virtual environment via the user device, where the at least one interactable element each is associated with image rendering data for rendering a corresponding appearance of the virtual object. The solution further includes detecting a predetermined operation of a user on an interactable element among the at least one interactable element, and in response to detecting the predetermined operation for the interactable element, a corresponding appearance of the virtual object is rendered with image rendering data associated with the interactable element.

In this way, the user can select the appearance of the virtual object according to personal preference, so that the avatar presents different visual effects, which not only enhances the interest of interaction, but also improves the interactive experience of the user.

The term “appearance” as used herein refers to an element that may be applied to a virtual object in a virtual environment. As an example, the appearance of the virtual object may include a skin or outfit of the virtual object. In the following, skin will be described as an example of the appearance for illustrative purposes. Virtual elements may be switched between different appearances to present different visual effects, where the change of visual effects involves at least one of: color, brightness, style, dynamic effects, etc.

In some embodiments below, a virtual manipulation member will be discussed as an example of a virtual object. However, it should be understood that the above example virtual objects should not be construed as limitations of the present disclosure. In fact, the solution of the present disclosure is applicable to any virtual object in a virtual environment that supports presenting different visual effects by changing the appearance. The present disclosure is not limited in this respect.

Further, in some embodiments below, the handle will be discussed as an example of a manipulation member. However, it should be understood that the above example manipulation member should not be construed as limiting the present disclosure. In fact, the manipulation member may be implemented in any form such as a handle, a keyboard, etc. In other words, the present disclosure is not limited in terms of the specific implementation form of the manipulation member.

In some embodiments below, the virtual reality VR environment will be discussed as an example of a virtual environment. However, it should be understood that the above example virtual environment should not be construed as a limitation of the present disclosure. In fact, the solution of the present disclosure is applicable to any virtual environment, including but not limited to VR environment, augmented reality AR environment, augmented reality XR environment and any other virtual environment based on 3D model. When the virtual environment is an AR/XR environment, the AR/XR apparatus can superimpose the virtual object with the pictures in the real world and present them in the AR/XR environment. In this way, the image appearing in the user's field of view includes both physical objects in the real world and virtual objects, so that the user can see both virtual objects and physical objects at the same time. In this case, the user can change the appearance of the avatar through the interactive process discussed in the present disclosure.

In some embodiments below, the virtual mall is taken as an example application scenario in which users perform interactive processes. However, it should be understood that the above example application scenarios should not be construed as limiting the present disclosure. In fact, the interaction process, such as the process of selecting an interactable element/switching an appearance, may be implemented via a user's request in any appropriate application scenario. The present disclosure is not limited in this respect.

Various example embodiments of the present disclosure will be described below in conjunction with the drawings.

### Example Environment

FIG. 1 shows a schematic diagram of an example environment 100 in which embodiments of the present disclosure can be implemented. Example environment 100 includes user 110 and his/her user device 120. In this example environment 100, the user device 120 is installed with and runs an application (hereinafter referred to as a control module) supporting the virtual environment, thereby supporting the presentation of the virtual environment 130 to the user 110 at or by the user device 120.

In some embodiments, the virtual environment 130 is a VR environment. As shown in FIG. 1, the user device 120 may be a head-mounted VR device. When the user 110 wears the user device 120, a virtual environment 130 may be displayed for the user 110, which may include a plurality of virtual objects.

Additionally, the user 110 can input an instruction in the virtual environment 130 via a manipulation member. Specifically, a virtual manipulation member, such as a virtual handle, may be presented in the virtual environment 130. In some embodiments, the virtual manipulation member may correspond to a physical manipulation member in the real world, such as the physical manipulation member 112 shown in FIG. 1. In this case, the control module can detect the first operation instruction input by the user 110 via the physical manipulation member, and map the first operation instruction in the real world to the second operation instruction in the virtual environment based on the association relationship between the physical manipulation member and the virtual operation member. In this way, human-computer interaction in a virtual environment is realized.

In some embodiments, the virtual environment is an AR/XR environment. In this specific virtual environment, the user device 120 may be any type of AR/XR device, including but not limited to a mobile terminal, a fixed terminal or a portable terminal, including a mobile phone, a desktop computer, a laptop computer, a notebook computer, a netbook computer, a tablet computer, a media computer, a multimedia tablet, a gaming device, a wearable device, a personal communication system (PCS) device, a personal navigation device, a personal digital assistant (PDA), an audio/video player, a digital camera/camcorder, a positioning device, a television receiver, a radio broadcast receiver, an e-book device or any combination of the foregoing, including accessories and peripherals of these devices or any combination thereof. In some embodiments, the user device 120 can also support any type of user-oriented interface (such as “wearable” circuits, etc.).

As shown in FIG. 1, the environment 100 optionally includes a remote device 140 with which the user device 120 can communicate. In some embodiments, the remote device 140 may be a cloud server.

It should be understood that the remote device 140 may include at least one of one or more servers, a cloud computing platform and a virtualization center. It should also be understood that in some embodiments, the remote device 140 is a background service that supports the 3D virtual environment application. In some embodiments, a specific process may be cooperatively implemented by the remote device 140 and the user device 120. For example, in some embodiments, the remote device 140 undertakes the primary computing work and the computing device 120 undertakes the secondary computing work. Alternatively, in other embodiments, the remote device 140 undertakes the secondary computing work and the user device 120 undertakes the primary computing work. Alternatively, in some embodiments, specific processes may be implemented independently by the remote device 140 or the user device 120.

In short, although in some embodiments some operations are described as being implemented by the user device 120, these operations may be implemented at least partially by the remote device 140. Correspondingly, although some operations are described as being implemented by remote device 140, these operations can at least partially be implemented by user device 120. For the sake of brevity only, the same or similar descriptions will be omitted.

It should be understood that the structure and function of environment 100 are described for illustrative purposes only and do not imply any limitation on the scope of the present disclosure.

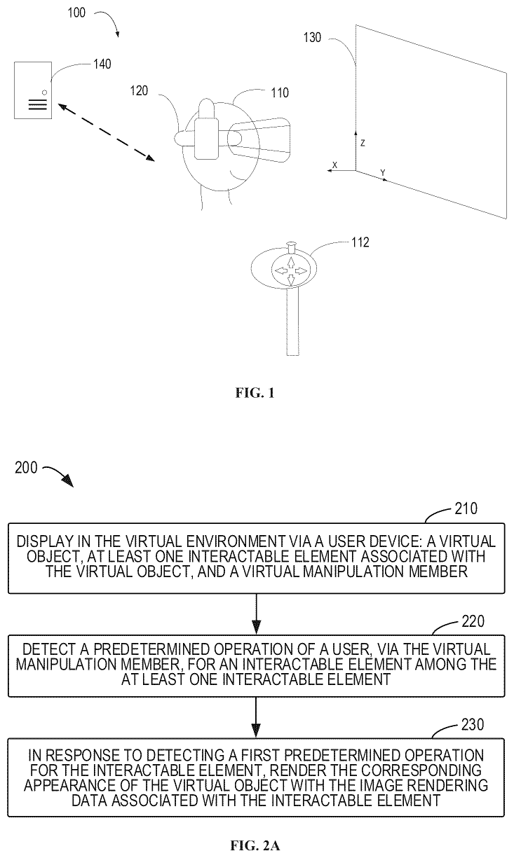

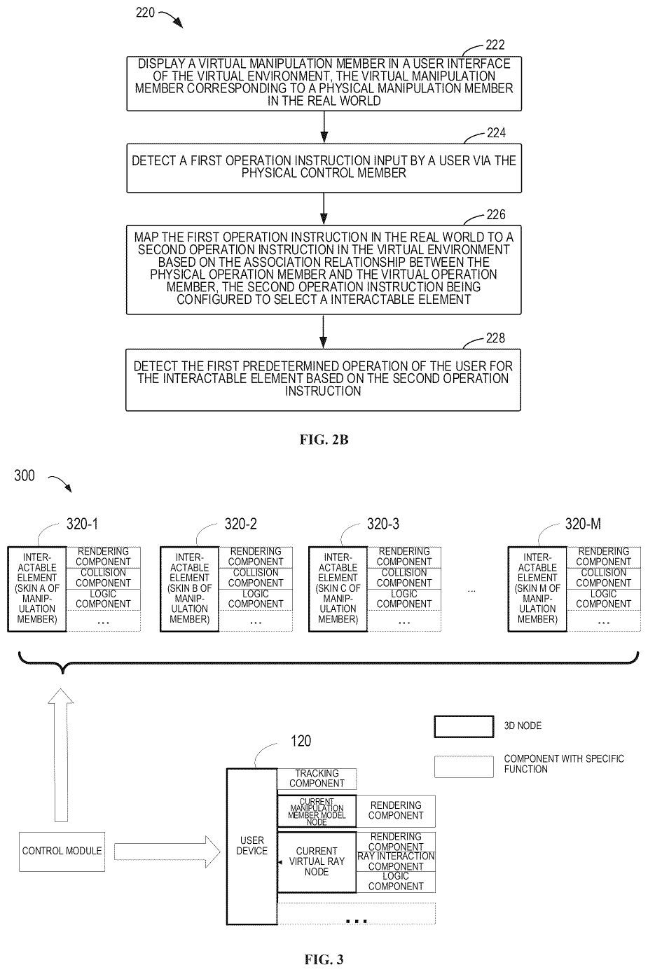

Example Process FIG. 2A shows a flowchart of a method 200 for interacting in a virtual environment according to some embodiments of the present disclosure. In some embodiments, the method 200 may be implemented at the user device 120 shown in FIG. 1, for example, by a control module of the user device 120.

According to an embodiment of the present disclosure, the control module may display at least one virtual object in the virtual environment 130. According to the example embodiments described below, the control module can realize personalized display of the avatar by changing the appearance, for example, the skin for the avatar.

At block 210, the control module of the user device 120 displays, via the user device 120, a virtual object, at least one interactable element associated with the virtual object and a virtual manipulation member in the virtual environment 130. The at least one interactable element each is associated with image rendering data for rendering the corresponding skin of the virtual object and the virtual manipulation member corresponds to a physical manipulation member in the real world.

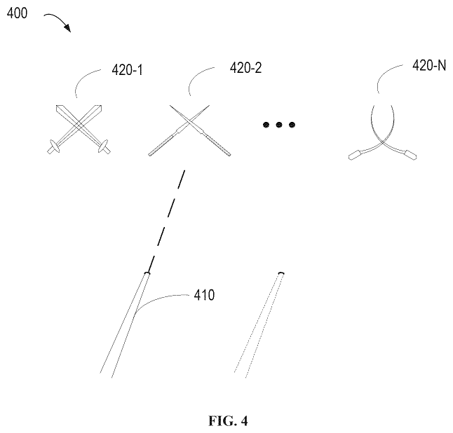

For ease of understanding, reference is made to FIG. 3 and FIG. 4, where FIG. 3 shows an example interactive system block diagram 300 in a virtual environment according to some embodiments of the present disclosure, and FIG. 4 shows an example virtual environment 400 according to some embodiments of the present disclosure.

In the specific embodiment of FIG. 3, the interactable element 320-1 to 320-M (where M is a positive integer greater than or equal to 1) correspond to the skin A to the skin M applicable to the virtual object, respectively. In this case, the control module displays the interactable element 320-1 to 320-4 in the virtual environment 130. In the specific embodiment of FIG. 3, the virtual object may be a virtual manipulation member, and the skin A to the skin M are skins suitable for the virtual manipulation member.

In the specific embodiment of FIG. 4, the virtual object is a virtual manipulation member, such as the virtual handle 410 shown in FIG. 4. At this time, interactable elements 420-1 to 420-N (where M is a positive integer greater than or equal to 1) may be displayed in the virtual environment 400.

In this way, the user 110 may be made to know the candidate skin information of the virtual object intuitively and clearly.

In some embodiments, the user device 120 may acquire information of the interactable element via the remote device 140. For example, other users or service providers can design corresponding skins for avatar and upload image rendering data for rendering the corresponding skins to the remote device 140. The user device 120 can establish a connection with the remote service 140 to acquire the corresponding information of the candidate skin and display it in the virtual environment 400 in the form of interactable elements.

At block 220, the control module detects a first predetermined operation of a user for an interactable element among the at least one interactable element. At block 230, in response to detecting a first predetermined operation for the interactable element, the control module renders a corresponding appearance of the virtual object with the image rendering data associated with the interactable element. In the following, for ease of description and without any limitation, the interactable element for which the predetermined operation of the user is detected may be also referred to as a specific interactable element. The specific interactable element may be any interactable element of the at least one interactable element. In the specific embodiment of FIG. 4, the virtual object is a virtual handle 410, when the first predetermined operation for the interactable element 420-2 is detected (e.g., the interactable element 420-2 is selected), the skin of the virtual handle 410 will be rendered using the image rendering data associated with the interactable element 420-2, that is, the virtual handle 410 will be rendered as a 3D model shown by the interactable element 420-2.

It should be understood that the downloading of the image rendering data associated with the interactable element 420-2 may be pre-downloaded or may be dynamically triggered in response to the first predetermined operation. The present disclosure is not limited in terms of the downloading timing of the image rendering data.

In this way, virtual objects in a virtual environment are no longer limited to a single rendering model and rendering effect. The user 110 can select and switch between a plurality of candidate skins to select a personalized skin for the avatar through a first predetermined operation. The above interaction process is intuitive and convenient, which not only meets the personalized needs of users but also improves the user's interaction experience.

In the specific embodiment where the virtual object is a virtual handle, there are usually two virtual handles. When the virtual controllers are rendered using the image rendering data associated with the interactable element 420-2, the two virtual controllers will be rendered simultaneously.

Next, an example process 220 in which the control module detects a first predetermined operation of the interactable element will be further described with reference to FIG. 2B.

At block 222, the control module may display a virtual manipulation member in the virtual environment 130, where the virtual manipulation member may correspond to a physical manipulation member in the real world. For easier understanding, refer to FIG. 1 and FIG. 4. In the specific embodiment of FIG. 4, a virtual manipulation member, illustrated as a virtual handle 410, is displayed in the virtual environment 400. Further, the virtual manipulation member may correspond to the physical manipulation member 112 in FIG. 1.

In some embodiments, the user device 120 may also be operated in a gesture mode. In the gesture mode, the user 110 can implement various predetermined operations through various gestures. In this case, the physical manipulation member may be a portion of the user's body, such as the hand of the user 110, and the virtual manipulation member may be displayed as a model of the hand. At this point, a plurality of interactable elements can correspond to different hand models.

At block 224, the control module detects a first operation instruction input by a user via the physical manipulation member. At block 226, the control module maps a first operation instruction in the real world to a second operation instruction in the virtual environment 130 based on the association between the physical operation member and the virtual operation member, where the second operation instruction is used to select the interactable element. Next, at block 228, the control module may detect a first predetermined operation of the user on the interactable element based on the second operation instruction.

In some embodiments of the present disclosure, the user device 120 may control the virtual manipulation member of the user device 120 to operate in different operation modes according to the distance of a virtual object (such as an interactable element) to be interacted with from the user 110 in the virtual environment 130.

Specifically, the user device 120 can present a virtual object in a specific spatial position of the virtual environment 130. The user 110 can observe the virtual object through the user device 120, such as a head-mounted VR device, and visually and intuitively feel the spatial distance from the virtual object in the virtual environment 130. That is to say, the user device 120 can present a spatially well-organized virtual environment 130 to the user 110 by presenting different virtual objects at different spatial locations of the virtual environment 130.

According to some embodiments of the present disclosure, the spatial distance may be determined by the user device 120, and further, the user device 120 can control the operation of the virtual manipulation member to switch between different operation modes according to the spatial distance between the virtual object and the user 110 in the virtual environment 130. In this way, the manipulation experience of the user 110 in the virtual environment 130 will be more realistic.

In some embodiments, the spatial distance refers to the distance in the virtual space between the virtual object and the user 110/a portion of the user 110 (such as eyes)/the user device 120/a portion of the user device 120 (such as a VR imaging member).

In some embodiments, if the distance between the virtual object to be interacted with and the user 110 in the virtual environment 130 is less than (or less than or equal to) a threshold distance, the virtual manipulation member is operated in the near view mode. At this time, the user 110 can directly contact/touch/control the virtual object through the virtual manipulation member.

In some embodiments, the control module displays the virtual ray emitted by the virtual manipulation member in the virtual environment 130, where the direction of the virtual ray is controlled based on the second operation instruction.

Additionally, the display of virtual ray is triggered based on certain conditions. In some embodiments, if the distance between the virtual object to be interacted with and the user 110 in the virtual environment 130 is more than a threshold distance, the virtual manipulation member is operated in the distant view mode. When the virtual manipulation member is operated in the distant view mode, the control module displays the virtual ray emitted by the virtual manipulation member in the virtual environment 130, where the direction of the virtual ray is controlled based on the second operation instruction.

Further, in some embodiments, the control module detects whether the virtual ray points to a interactable element, and determines that the interactable element is selected if it is detected that the virtual ray points to the interactable element.

The virtual ray can extend the controllable range of the user 110 in the virtual environment. In addition, the virtual ray enables the user 110 to select the desired interactable element more accurately. Most importantly, virtual ray makes the interaction in the virtual environment more real and interesting, and improves the user experience.

In the specific implementation of FIG. 4, the control module may display the virtual ray emitted by the virtual handle 410 and control the direction of the virtual ray to point to different interactable elements 420 based on the second operation instruction. In this way, the selection of different interactable element 420 is realized.

In some embodiments, the virtual ray is a portion of the virtual manipulation member, and when the rendering mode/data of the virtual manipulation member changes, the rendering mode/data of the virtual ray also changes accordingly.

Next, how to detect the first predetermined operation for the interactable element will be described in detail with reference to FIG. 3.

In the specific implementation of FIG. 3, a plurality of 3D nodes and a plurality of components with specific functions are included. In addition, the interaction process discussed in the present disclosure may be driven and controlled by corresponding system logic.

As shown in FIG. 3, in some embodiments, each interactable element 320 may have a rendering component, where the rendering component defines a rendering style of the skin to be displayed. At least one of the following data may be encapsulated in the rendering component: rendering data, rendering suite, rendering material, etc. In this way, each interactable element 320/skin may be managed independently, and the system maintenance cost will be reduced.

Alternatively or additionally, in some embodiments, each interactable element 320 may also have a collision component, where the collision component is used to detect whether the interactable element is selected. In a specific embodiment, the control module can determine the spatial position of each interactable element 320 in the virtual environment 130, and further determine the collision range of each interactable element based on the spatial position. When a collision signal is detected within the collision range, the interactable element is considered to be selected. For example, the user 110 may control the virtual ray of the virtual manipulation apparatus to point to the predetermined collision range, and further confirm the selection of the interactable element by pressing a confirmation button or other operations.

Alternatively or additionally, in some embodiments, each interactable element 320 may further include a logic component for implementing the processing logic of the interactable element 320. In some embodiments, when the virtual ray points to the interactable element 320, the logic component may display multimedia information associated with the interactable element 320 in a manner such as animation. Further, when the interactable element 320 is selected, the logic component can also assist in triggering the switching of the corresponding skin.

The specific embodiment of FIG. 3 further includes a user device 120, which may be used as a virtual manipulation member. In some embodiments, the user device 120 may be implemented as a globally universal interactive manipulation node. Further, the user device 120 can realize human-computer interaction in a virtual environment based on a 3D model.

In some embodiments, the user device 120 may include a tracking component that can track the position and attitude of the inertial measurement unit IMU of the physical manipulation member in real time, so that the virtual manipulation member in the virtual environment 130 may be matched with the physical manipulation member in the real world.

Alternatively or additionally, the user device 120 may further include a currently manipulation member model node. As shown in FIG. 3, the currently manipulation member model node may have a rendering component that defines the rendering style of the current appearance of the virtual manipulator node. At least one of the following data may be encapsulated in the rendering component: rendering data, rendering suite, rendering material, etc.

Alternatively or additionally, in some embodiments, the user device 120 may further include a current virtual ray node. The current virtual ray node may include a rendering component, where the rendering component is used to draw the rendering style of the virtual ray of the current collision interaction. Alternatively or additionally, the current virtual ray node may further include a ray interaction component, where the ray interaction component may generate virtual ray data according to the tracking data, and cooperate with a collision component of the interactable element 320 to implement collision detection. Alternatively or additionally, the current virtual ray node may further include a logic component, where the logic component is used to execute processing logic such as updating the length of the virtual ray display according to the collision result.

In the specific embodiment of FIG. 3, the overall flow of the interaction process with the interactable element 320 may be implemented by the control module. Specifically, the control module drives the ray interaction component of the user device 120 to perform collision detection with each collision component of the interactable element 320. If the first predetermined operation of the user 110 for a specific interactable element 320 is detected, the rendering update of the virtual manipulation member and/or the virtual ray is triggered. For example, when a collision is detected between the collision component of the interactable element 320-1 and the user 110 clicks the confirmation button on the physical manipulation member, the logic component of the interactable element 320-1 notifies the control module to trigger the control module to use the image rendering data associated with the interactable element 320-1 to render the corresponding skin of the virtual manipulation member and/or the virtual ray.

In some embodiments, the control module caches the rendering component of the current manipulation member model node and the rendering component of the current virtual ray node, and replaces the rendering component of the current manipulation member model node and/or the rendering component of the current virtual ray node with the rendering component of the interactable element 320-1.

According to some embodiments of the present disclosure, at least one interactable element may be displayed only when the virtual environment is switched to a specific application scenario, in which the user 110 can select his favorite skin for the avatar through a first predetermined operation. Further, in this specific application scenario, the user 110 may associate the specific interactable element with the user 110 through a second predetermined operation. Next, when the virtual environment is switched to another application scenario, the corresponding skin of the virtual object will continue to be rendered using the image rendering data of the interactable element under the condition that the interactable element has been associated with the user 110, and the corresponding skin of the virtual object will stop being rendered using the image rendering data of the interactable element under the condition that the interactable element has not been associated with the user.

As a specific embodiment, the control module switches the virtual environment to the first application scenario in response to receiving the user's first scenario switching instruction, and associates the interactable element with the user 110 if the control module detects a second predetermined operation for the interactable element in the first application scenario.

Further, in some embodiments, the control module receives a second scenario switching instruction from the user and switches the virtual environment from the first application scenario to the second application scenario. At this time, if the interactable element has been associated with the user, the control module continues to render the corresponding skin of the virtual object with the image rendering data of the interactable element, otherwise, the control module ceases the rendering of the corresponding skin of the virtual object with the image rendering data of the interactable element.

Further, the control module may record whether the second predetermined operation is detected by using a marker bit. In this case, after switching to the second scenario, if the control module determines that the marker bit is marked, it is allowed to continue to render the corresponding skin of the virtual object with the image rendering data of the interactable element, otherwise, the control module ceases the rendering of the corresponding skin of the virtual object with the image rendering data of the interactable element. Optionally, the marker bit may be displayed superimposed with the interactable element. In this way, the image rendering data of the interactable elements may be maintained more reasonably.

In the specific embodiment where the virtual mall is the first application scenario and the virtual object is the virtual manipulation member, the user can switch to the virtual mall, especially the skin shop in the virtual mall through the first scenario switching instruction. In the scenario of a virtual mall, a plurality of interactable elements may be presented, and each interactable element corresponds to a corresponding skin of the virtual manipulation member, as shown in FIG. 4. In this first application scenario, the user 110 can switch between a plurality of interactable elements through a first predetermined operation. With different selections made by the user 110, the virtual handle 410 is rendered into different 3D models, each of which corresponds to a corresponding interactable element 420.

Further, if a second predetermined operation for an interactable element is detected in the first application scenario, such as the user 110 purchasing the specific skin, the interactable element may be associated with the user 110, that is, the ownership of the skin by the user 110 may be determined.

Next, after entering the second application scenario, if the second predetermined operation has been detected/the association between the interactable element and the user 110 has been established/the mark has been detected to be marked/it has been determined that the user 110 has purchased the skin, the skin can continue to be used after the user 110 leaves the virtual mall. On the contrary, if the second predetermined operation has not been detected before/the association between the interactable element and the user 110 has not been established/the mark is detected to be not marked/it is determined that the user 110 has not purchased the skin, then after the user 110 leaves the virtual mall, the visual effect of the virtual handle 410 will be reverted to the previous 3D model.

With further reference to the specific embodiment of FIG. 3, if it is determined that the user 110 has not purchased the skin corresponding to the interactable element 320-1, then when entering the second application scenario, the control module will use the rendering component previously cached in the current manipulation member model node and the rendering component of the current virtual ray node to render the virtual manipulation member and the virtual ray. If it is determined that the user 110 has purchased the skin corresponding to the interactable element 320, then when entering the second application scenario, the control module may continue to render the virtual manipulation member with the rendering component of the interactable element 320.

Further, in some embodiments, the control module hidden displays the interactable element or changes the display mode of the interactable element in the virtual environment 130 in response to the selection of the interactable element.

In the specific embodiment of FIG. 4, if the interactable element 420-2 is selected, the virtual handle 410 is rendered as a 3D model corresponding to the interactable element 420-2, and the interactable element 420-2 is hidden or the display mode is changed, such as, the color and/or shape and/or transparency are changed, or the interactable element 420-2 is displayed superimposed with other icons, etc. In this way, the user 110 can understand the information of the candidate skins more clearly.

Through the above embodiment, the user can select the skin of the virtual object according to personal preference, so that the avatar presents different visual effects, which not only enhances the interest of interaction, but also improves the interactive experience of the user.

### Example Apparatus and Device

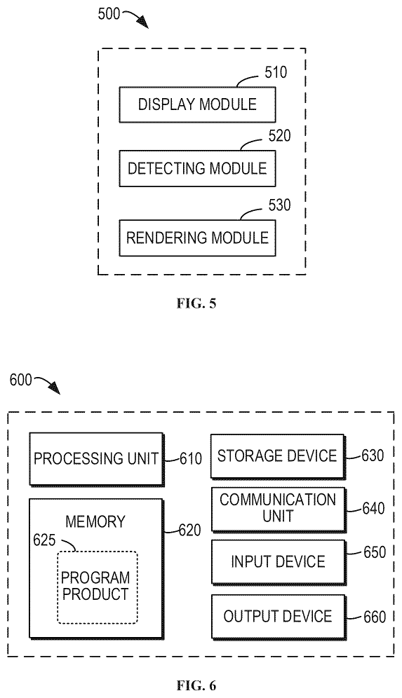

FIG. 5 shows a block diagram of an apparatus 500 for interacting in a virtual environment. As shown in the figures, the apparatus 500 includes: a display module 510 configured to display, via a user device, a virtual object, at least one interactable element associated with the virtual object, and a virtual manipulation member in a virtual environment, where the at least one interactable element each is associated with image rendering data for rendering corresponding appearance of the virtual object, and the virtual manipulation member corresponds to a physical manipulation member in the real world; a detecting module 520 configured to detect a predetermined operation of a user, via the virtual manipulation member, for an interactable element among the at least one interactable element; and a rendering module 530 configured to in response to detecting a first predetermined operation for the specific interactable element, render the corresponding appearance of the virtual object with the image rendering data associated with the interactable element.

In some embodiments, the detecting module 520 is further configured to detect a first operation instruction input by a user via the physical manipulation member; map the first operation instruction in the real world to a second operation instruction in the virtual environment based on the association relationship between the physical operation member and the virtual operation member, the second operation instruction being configured to select the interactable element; and detect the first predetermined operation of the user for the interactable element based on the second operation instruction.

In some embodiments, the apparatus 500 further includes a virtual ray module (not shown) configured to display, in the virtual environment, virtual ray emitted by the virtual manipulation member; and control a direction of the virtual ray based on the second operation instruction.

In some embodiments, the virtual ray module is further configured to in response to a distance between the interactable element and the user in the virtual environment being greater than a threshold distance, display the virtual ray.

In some embodiments, the detecting module 520 is further configured to detect whether the virtual ray points to the interactable element; and the method further includes in response to detecting that the virtual ray points to the interactable element, determining that the interactable element is selected.

In some embodiments, the physical manipulation member is one of: a physical manipulation member of the user device, or a portion of the user's body.

In some embodiments, the apparatus 500 further includes an association detecting module (not shown) configured to in response to receiving a first scenario switching instruction from the user, switch the virtual environment to a first application scenario; and in response to detecting a second predetermined operation for the interactable element in the first application scenario, associate the interactable element with the user.

In some embodiments, the apparatus 500 further includes an update display module (not shown) configured to: in response to receiving a second scenario switching instruction from the user, switch the virtual environment from the first application scenario to a second application scenario; in accordance with a determination that the interactable element is associated with the user, continue to render the corresponding appearance of the virtual object with the image rendering data of the interactable element; and in accordance with a determination that the interactable element is not associated with the user, cease render the corresponding appearance of the virtual object with the image rendering data of the interactable element.

In some embodiments, the apparatus 500 further includes a hidden display module (not shown) configured to in response to a selection of the interactable element, hide display, in the virtual environment, the interactable element or changing a display mode of the interactable element.

In some embodiments, the user device is a head-mounted virtual reality VR device, and the virtual object is a virtual manipulation member.

The units included in the apparatus 500 may be implemented in various ways, including software, hardware, firmware or any combination thereof. In some embodiments, one or more units may be implemented using software and/or firmware, e.g., machine-executable instructions stored on a storage medium. In addition to or as an alternative to machine-executable instructions, some or all of the units in apparatus 500 may be at least partially implemented by one or more hardware logic components. By way of example and not limitation, example types of hardware logic components that may be used include field programmable gate arrays (FPGAs), application specific integrated circuits (ASICs), application specific standard products (ASSPs), systems on a chip (SOCs), complex programmable logic devices (CPLDs), and the like.

FIG. 6 shows a block diagram of a computing device 600 in which one or more embodiments of the present disclosure may be implemented. It should be understood that the computing device 600 shown in FIG. 6 is merely illustrative and should not constitute any limitation on the function and scope of the embodiments described herein. The computing device 600 shown in FIG. 6 may be used to implement the user device 110 of FIG. 1.

As shown in FIG. 6, the computing device 600 is in the form of a general-purpose electronic device. Components of computing device 600 may include, but are not limited to, one or more processors or processing units 610, memory 620, storage device 630, one or more communication units 640, one or more input devices 650, and one or more output devices 660. The processing unit 610 may be an actual or virtual processor and can perform various processes according to programs stored in the memory 620. In a multiprocessor system, a plurality of processing units execute computer-executable instructions in parallel to improve the parallel processing capability of the computing device 600.

Computing device 600 usually includes a plurality of computer storage medium. Such medium may be any available medium that may be accessed by the computing device 600, including but not limited to volatile and non-volatile medium, removable and non-removable medium. The memory 620 may be volatile memory (e.g., register, cache, random access memory (RAM)), non-volatile memory (e.g., read-only memory (ROM), electrically erasable programmable read-only memory (EEPROM), flash memory) or some combination thereof. Storage device 630 may be removable or non-removable medium and may include machine-readable medium e.g., a flash drive, a disk, or any other medium that may be capable of storing information and/or data (e.g., training data for training) and may be accessed within computing device 600.

The computing device 600 may further include additional removable/non-removable, volatile/non-volatile storage medium. Although not shown in FIG. 6, a disk drive for reading or writing from a removable, non-volatile magnetic disk (e.g., “floppy disk”) and an optical disk drive for reading or writing from a removable, non-volatile optical disk may be provided. In these cases, each drive may be connected to a bus (not shown) by one or more data medium interfaces. The memory 620 may include a computer program product 625 having one or more program modules configured to perform various methods or actions of various embodiments of the present disclosure.

The communication unit 640 realizes communication with other electronic devices through a communication medium. Additionally, the functions of the components of the computing device 600 may be implemented in a single computing cluster or a plurality of computing machines, which are capable of communicating through a communication connection. Therefore, the computing device 600 can operate in a networked environment using logical connections with one or more other servers, a network personal computer (PC) or another network node.

The input device 650 may be one or more input devices, e.g., a mouse, a keyboard, a trackball, etc. The output device 660 may be one or more output devices, e.g., a display, a speaker, a printer, etc. The computing device 600 may also communicate with one or more external devices (not shown) through the communication unit 640 as needed, such as, storage devices, display devices, etc., with one or more devices that enable a user to interact with the computing device 600, or with any device that enables the computing device 600 to communicate with one or more other electronic devices (e.g., a network card, a modem, etc.). Such communications may be performed via an input/output (I/O) interface (not shown).

According to an example implementation of the present disclosure, a computer-readable storage medium is provided, on which one or more computer instructions are stored, where the one or more computer instructions are executed by a processor to implement the mode described above.

Various aspects of the present disclosure are described herein with reference to flowcharts and/or block diagrams of methods, apparatus (systems) and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine such that when these instructions are executed by the processing unit of the computer or other programmable data processing apparatus, an apparatus is produced that implements the functions/actions specified in one or more blocks in the flowchart and/or block diagram. These computer-readable program instructions may also be stored in a computer-readable storage medium, which enables a computer, a programmable data processing apparatus and/or other device to work in a specific manner, so that the computer-readable medium storing the instructions includes a manufactured product, which includes instructions for implementing various aspects of the functions/actions specified in one or more blocks in the flowchart and/or block diagram.

Computer-readable program instructions may also be loaded onto a computer, other programmable data processing apparatus, or other device so that a series of operating steps are performed on the computer, other programmable data processing apparatus, or other device to produce a computer-implemented process, thereby causing the instructions executed on the computer, other programmable data processing apparatus, or other device to implement the functions/actions specified in one or more blocks in the flowchart and/or block diagram.

The flowcharts and block diagrams in the drawings show the architectures, functions and operations of possible implementations of systems, methods and computer program products according to a plurality of implementations of the present disclosure. In this regard, each block in the flowchart or block diagram may represent a module, a program segment or a portion of an instruction, and the module, a program segment or a portion of an instruction contains one or more executable instructions for implementing specified logical functions. In some alternative implementations, the functions noted in the blocks may also occur in a different order than those noted in the drawings. For example, two consecutive blocks may actually be executed substantially in parallel, or they may sometimes be executed in the reverse order, depending on the functions involved. It should also be noted that each block in the block diagrams and/or flowcharts, and combinations of blocks in the block diagrams and/or flowcharts, may be implemented by a dedicated hardware-based system that performs specified functions or actions, or may be implemented by a combination of dedicated hardware and computer instructions.

Various implementations of the present disclosure have been described above, and the above descriptions are illustrative, not exhaustive, and are not limited to the disclosed implementations. Many modifications and variations will be apparent to those of ordinary skill in the art without departing from the scope and spirit of the described implementations. The terms used in this document are selected to best explain the principles of each implementation, practical application or improvement of technology in the market, or to enable other ordinary technicians in this technical field to understand the various implementations disclosed in this document.

1. A method for interacting in a virtual environment, comprising:
displaying in the virtual environment via a user device:
a virtual object,
at least one interactable element associated with the virtual object, the at least one interactable element each being associated with image rendering data for rendering a corresponding appearance of the virtual object, and
a virtual manipulation member corresponding to a physical manipulation member in a real world;
detecting a predetermined operation of a user, via the virtual manipulation member, for an interactable element among the at least one interactable element; and
in response to detecting a first predetermined operation for the interactable element, rendering the corresponding appearance of the virtual object with the image rendering data associated with the interactable element.

2. The method of claim 1, wherein detecting the first predetermined operation of the user for the interactable element comprises:
detecting a first operation instruction input by the user via the physical manipulation member;
mapping the first operation instruction in the real world to a second operation instruction in the virtual environment based on the association relationship between the physical operation member and the virtual operation member, the second operation instruction being configured to select the interactable element; and
detecting the first predetermined operation of the user for the interactable element based on the second operation instruction.

3. The method of claim 2, further comprising:
displaying, in the virtual environment, a virtual ray emitted by the virtual manipulation member; and
controlling a direction of the virtual ray based on the second operation instruction.

4. The method of claim 3, wherein displaying, in the virtual environment, the virtual ray emitted by the virtual manipulation member comprises:
in response to a distance between the interactable element and the user in the virtual environment being greater than a threshold distance, displaying the virtual ray.

5. The method of claim 3, wherein detecting the first predetermined operation of the user for the interactable element based on the second operation instruction comprises:
detecting whether the virtual ray is points to the interactable element; and
wherein the method further comprises:
in response to detecting that the virtual ray points to the interactable element, determining that the interactable element is selected.

6. The method of claim 2, wherein the physical manipulation member is one of:
a physical manipulation member of the user device, or
a portion of a body of the user.

7. The method of claim 1, further comprising:
in response to receiving a first scenario switching instruction from the user, switching the virtual environment to a first application scenario; and
in response to detecting a second predetermined operation for the interactable element in the first application scenario, associating the interactable element with the user.

8. The method of claim 7, further comprising:
in response to receiving a second scenario switching instruction from the user, switching the virtual environment from the first application scenario to a second application scenario;
in accordance with a determination that the interactable element is associated with the user, continuing the rendering of the corresponding appearance of the virtual object with the image rendering data of the interactable element; and
in accordance with a determination that the interactable element is not associated with the user, ceasing the rendering of the corresponding appearance of the virtual object with the image rendering data of the interactable element.

9. The method of claim 1, further comprising:
in response to a selection of the interactable element, in the virtual environment, hiding the interactable element or changing a display mode of the interactable element.

10. The method of claim 1, wherein the user device is a head-mounted virtual reality, VR, device, and the virtual object is a virtual manipulation member.

11. (canceled)

12. An electronic device, comprising:
at least one processor; and
at least one memory coupled to the at least one processor and storing instructions executable by the at least one processor, the instructions when executed by the at least one processor, causing the electronic device to perform acts comprising:
displaying in the virtual environment via the user device:
a virtual object,
at least one interactable element associated with the virtual object, the at least one interactable element each being associated with image rendering data for rendering a corresponding appearance of the virtual object, and
a virtual manipulation member corresponding to a physical manipulation member in a real world;
detecting a predetermined operation of a user, via the virtual manipulation member, for an interactable element among the at least one interactable element; and
in response to detecting a first predetermined operation for the interactable element, rendering the corresponding appearance of the virtual object with the image rendering data associated with the interactable element.

13. The electronic device of claim 12, wherein detecting the first predetermined operation of the user for the interactable element comprises:
detecting a first operation instruction input by the user via the physical manipulation member;
mapping the first operation instruction in the real world to a second operation instruction in the virtual environment based on the association relationship between the physical operation member and the virtual operation member, the second operation instruction being configured to select the interactable element; and
detecting the first predetermined operation of the user for the interactable element based on the second operation instruction.

14. The electronic device of claim 13, wherein the acts further comprise:
displaying, in the virtual environment, a virtual ray emitted by the virtual manipulation member; and
controlling a direction of the virtual ray based on the second operation instruction.

15. The electronic device of claim 14, wherein displaying, in the virtual environment, the virtual ray emitted by the virtual manipulation member in the virtual environment comprises:
in response to a distance between the interactable element and the user in the virtual environment being greater than a threshold distance, displaying the virtual ray.

16. The electronic device of claim 14, wherein detecting the first predetermined operation of the user on the interactable element based on the second operation instruction comprises:
detecting whether the virtual ray points to the interactable element; and
wherein the acts further comprise:
in response to detecting that the virtual ray points to the interactable element, determining that the interactable element is selected.

17. The electronic device of claim 13, wherein the physical manipulation member is one of:
a physical manipulation member of the user device, or
a portion of a body of the user.

18. The electronic device of claim 12, wherein the acts further comprise:
in response to receiving a first scenario switching instruction from the user, switching the virtual environment to a first application scenario; and
in response to detecting a second predetermined operation for the interactable element in the first application scenario, associating the interactable element with the user.

19. The electronic device of claim 18, wherein the acts further comprise:
in response to receiving a second scenario switching instruction from the user, switching the virtual environment from the first application scenario to a second application scenario;
in accordance with a determination that the interactable element is associated with the user, continuing the rendering of the corresponding appearance of the virtual object with the image rendering data of the interactable element; and
in accordance with a determination that the interactable element is not associated with the user, ceasing the rendering of the corresponding appearance of the virtual object with the image rendering data of the interactable element.

20. The electronic device of claim 12, wherein the acts further comprise:
in response to a selection of the interactable element, in the virtual environment, hiding the interactable element or changing a display mode of the interactable element.

21. (canceled)

22. A non-transitory computer-readable storage medium having a computer program stored thereon, the computer program, when executed by a processor, performing acts comprising:
displaying in the virtual environment via a user device:
a virtual object,
at least one interactable element associated with the virtual object, the at least one interactable element each being associated with image rendering data for rendering a corresponding appearance of the virtual object, and
a virtual manipulation member corresponding to a physical manipulation member in a real world;
detecting a predetermined operation of a user, via the virtual manipulation member, for an interactable element among the at least one interactable element; and
in response to detecting a first predetermined operation for the interactable element, rendering the corresponding appearance of the virtual object with the image rendering data associated with the interactable element.

23. (canceled)
